(19) United States
(12) Patent Application Publication
(10) Pub. No.: US 2017/0066082 A1
(43) Pub. Date: Mar. 9, 2017

(54) LASER WELDED SWITCHES

(71) Applicant: Apple Inc., Cupertino, CA (US)

(72) Inventors: Xiao Ying ZHAO, Santa Clara, CA (US); Daniel W. JARVIS, Sunnyvale, CA (US); Richard Hung Minh DINH, Saratoga, CA (US); Andrew T. ERICKSON, Wauwatosa, WI (US)

(21) Appl. No.: 15/097,100

(22) Filed: Apr. 12, 2016

Related U.S. Application Data
(60) Provisional application No. 62/214,582, filed on Sep. 4, 2015.

(51) Int. Cl. B23K 26/22; H01H 9/02; H01H 11/00; B23K 26/323

(52) U.S. Cl. CPC B23K 26/22; B23K 26/323; H01H 9/02; H01H 11/00; H01H 2011/0087

(57) ABSTRACT

This application relates to systems, methods, and apparatus for welding switches to a bracket for placement inside of a computing device. Each switch can include a metal region that can be welded to a metal surface of a bracket. The metal region of the switch can be a cover that is formed around a body of the switch, or an inserted molded region that is provided on a surface of the switch. The bracket can include recesses that can be used to identify when a switch is abutting the bracket before welding the switch to the bracket. Multiple welds can be provided on each switch to ensure a rigid connection exists between the bracket and switch. Welding can be performed in batches by loading multiple brackets and switches onto a pallet, and thereafter loading the pallet into a welding machine.

### CROSS-REFERENCE TO RELATED APPLICATIONS

This Application claims the benefit of U.S. Provisional Application No. 62/214,582, entitled “LASER WELDED SWITCHES”, filed Sep. 4, 2015, the contents of which is incorporated by reference herein in its entirety for all purposes.

### FIELD

The described embodiments relate generally to switches for a portable computing device. More particularly, the present embodiments relate to techniques for attaching a switch to a bracket of a computing device using various welding techniques.

### BACKGROUND

Developing reliable device parts has proved more difficult as many devices become more compact. Although certain features of a device may seem more useful when provided in a portable format, the fragility of many internal structures within the device may be inadequate as a result of being manufactured for compact devices. Consequently, certain assemblies for components such as switches and buttons can ware quickly and eventually become inoperable. Although some techniques exist for improving rigidity of internal connections within a device, the repeatability and manufacturability of such techniques can prove arduous for large-scale testing and manufacturing.

### SUMMARY

This paper describes various embodiments that relate to welded switches. In some embodiments, a method for welding a bracket to a switch is set forth. The method can include positioning a welder at a distance from a recess on the bracket. During positioning, the switch can be placed against the bracket on a surface of the bracket opposite the recess. The method can further include identifying a location of a reference hole or indicia on the bracket, and moving the welder toward the recess based on the location of the reference hole or indicia. Additionally, the method can include laser welding the bracket at the recess to attach the bracket to a metal surface of the switch.

In other embodiments, a switch assembly is set forth. The switch assembly can include a bracket with a recess, and a switch. The switch can be connected to the bracket at multiple laser welded regions. Each of the multiple laser welded regions are formed from at least one bracket surface defined by a recess and a metal surface of the switch. The metal surface of the switch can be a portion of a switch cover that is disposed over multiple edges of the switch.

In yet other embodiments, a method for manufacturing a switch assembly is set forth. The method can include a step of identifying a reference hole or indicia on a bracket that is placed against a metal surface of a switch. The method can further include a step of determining a weld location on the bracket based on the identifying of the reference hole or indicia. The method can also include a step of laser welding the portion of the bracket to the metal surface of the switch. The metal surface can include a pin that extends through at least one of the multiple recesses of the bracket when the welding is performed.

Other aspects and advantages of the invention will become apparent from the following detailed description taken in conjunction with the accompanying drawings which illustrate, by way of example, the principles of the described embodiments.

### BRIEF DESCRIPTION OF THE DRAWINGS

The disclosure will be readily understood by the following detailed description in conjunction with the accompanying drawings, wherein like reference numerals designate like structural elements.

FIG. 1 illustrates a perspective view of a portable computing device that includes a switch.

FIG. 2A illustrates a perspective view of a switch body that can be a part of the switch of the computing device.

FIG. 2B illustrates a perspective view of the bracket that can be secured within the computing device with the switch.

FIG. 2C illustrates a perspective view of the switch wrapped in a switch cover that can assist in securing the switch to the bracket.

FIGS. 2D-2F illustrate cross-sections of different embodiments of the switch cover.

FIG. 3A illustrates a perspective view of an embodiment of a bracket having a surface defined by recesses for welding a switch cover to the bracket.

FIG. 3B illustrates a perspective view of the switch cover welded to the bracket using one or more welds.

FIGS. 4A-4D illustrate perspective views of embodiments of switches that can be secured to the bracket.

FIG. 5A illustrates a perspective view of an assembly for securing a switch to a bracket using asymmetric alignment pins.

FIG. 5B illustrates a perspective view of the switch cover secured to the bracket using welds.

FIG. 5C illustrates multiple welds that can secure surfaces of the switch cover adjacent to the switch.

FIG. 6 illustrates a perspective view of an embodiment of a switch assembly that includes a bracket connected to a switch and a switch cover.

FIGS. 7A and 7B illustrate steps for welding a switch to a bracket.

FIGS. 8A-8C illustrate cross-sectional views of welds that can be created to attach any of the switches and brackets discussed herein.

FIG. 9 illustrates a perspective view of a pallet of brackets and switches that can be connected together using a batch welding process.

FIG. 10 illustrates a method for welding a bracket to a switch.

FIG. 11 illustrates a method for performing a batch welding process to individually weld multiple brackets to multiple switches.

### DETAILED DESCRIPTION

Representative applications of methods and apparatus according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

In the following detailed description, references are made to the accompanying drawings, which form a part of the description and in which are shown, by way of illustration, specific embodiments in accordance with the described embodiments. Although these embodiments are described in sufficient detail to enable one skilled in the art to practice the described embodiments, it is understood that these examples are not limiting; such that other embodiments may be used, and changes may be made without departing from the spirit and scope of the described embodiments.

Designing compact devices can prove difficult when certain devices incorporate small components that endure much physical movement during the lifetime of the devices. An example of such components includes switches and buttons, which are oftentimes subject to physical force over the lifetime of a device. If the components are not adequately secured within the device, the components can become inoperable and cause the device to malfunction. The embodiments discussed herein relate to systems, methods, and apparatus for securing a component into a device. In some embodiments, the component is a switch that can be laser welded to a bracket within the device. The switch can be wrapped in a metal cover and welded to the bracket to create a metal on metal connection between the switch and the bracket. The metal cover can be a single piece cover or a multiple piece cover that wraps around a plastic body of the switch. When the metal cover is a multiple piece cover, each piece of the multiple piece cover can be welded together after assembly of the multiple piece cover around the plastic body of the switch. In some embodiments, the switch can be inserted molded to include a metal surface for welding the switch to the bracket. In this way, the insert molded metal surface can be flush with a plastic surface of the switch, or extend out of the plastic surface for welding the metal surface to the bracket.

The bracket to which the switch is welded can include a hole or other indicia for locating the switch when welding the switch to the bracket. Recesses of the bracket can be welded to the switch to form the metal to metal bond between the switch and the bracket. In some embodiments, the bracket can be formed without recesses at the area(s) where the switch is to be welded. In this way, a metal surface of the switch or enclosure of the switch is welded to the bracket through a planar surface of the bracket. It should be noted the processing of welding as discussed herein can refer to any form of welding suitable for bonding an electrical component to a structure, not limited to a bracket. For example, laser welding can be used to attach the switch and brackets, as discussed herein.

During welding of the switch to the bracket, a sensor can be used to identify a location on the bracket for welding the bracket to the switch. In order to assist the sensor, a reference location or indicia on the bracket can be identified by the sensor as a reference point for determining where on the bracket welds are to be provided. In some embodiments, the sensor can directly identify the weld locations without using a reference location separate from the weld locations. Sliders can be used to position the switch for welding. For example, a slider can be used to offset the switch from an edge of the bracket by positioning a slider at an edge of the bracket. Sliders can be pressed against the sides of the switch to secure the switch in place during welding of the switch and bracket. Once the switch is placed against the bracket, the welder (e.g., a laser welder) can be positioned a distance from the bracket to ensure that a rigid bond between the switch and bracket can be created as a result of the weld. The welder can be positioned over each weld location (e.g., a recess in the bracket or an indicia on the bracket), or be positioned over a location near the weld locations and thereafter pivot or rotate to reach each weld location. Each individual weld on the bracket can be performed in a period of milliseconds, and pauses between individual welds can be included in the welding process to ensure that the heat from each weld has dissipated before another weld is performed. Additionally, the welder can be cleaned between one or more welds to minimize material interference between the welder and the bracket.

During a cycle of welding a switch and bracket, welding can be performed on a group of switches and brackets in a batch process. For example, multiple switches and brackets can be placed into a pallet and loaded into a welding machine for welding. During welding, a weld can first be made on each bracket before a subsequent weld is made on a bracket to allow the heat generated from the previous weld to dissipate before the next weld. In some embodiments, welds on multiple brackets within a pallet can be made concurrently. When laser welding is used to weld a switch to a bracket, the power of the laser can be adjusted based on the weld that is to be made on the bracket. Furthermore, a feedback mechanism can be incorporated into the welding process to adjust the power of the laser based on a thickness of the bracket and/or metal surface on the switch. The thickness can be determined by a sensor that can provide data from which dimensions of the bracket and/or switch can be derived. The power of the laser welder can be increased when a bracket and/or switch surface thickness increases, or decrease when a bracket and/or switch surface thickness decreases. In this way, rigidity of welds can be maximized by ensuring that the power of the laser is not too little such that a weak weld is formed, and not too strong such that the bracket and/or switch is rendered inoperable by the weld.

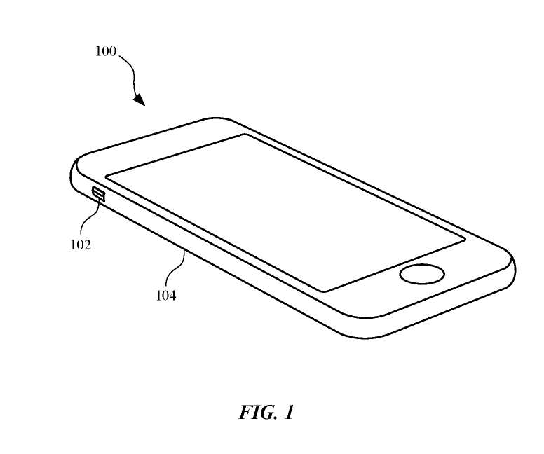

These and other embodiments are discussed below with reference to FIGS. 1-11; however, those skilled in the art will readily appreciate that the detailed description given herein with respect to these figures is for explanatory purposes only and should not be construed as limiting.

FIG. 1 illustrates a perspective view 100 of a computing device 104 that includes a switch 102. The computing device 104 can be any type of device not limited to a cellular phone, laptop, media player, desktop computer, watch, display, or any other suitable device that can include a switch. The switch 102 can be connected to one or more circuits within the computing device 104 to execute certain features of the computing device 104. For example, in some embodiments, the switch 102 is connected to a circuit that allows the switch 102 to lock the computing device 104 until a user of the computing device 104 unlocks the computing device 104. In other embodiments, the switch 102 can be used to turn on and off one or more features of the computing device 104 such as audio, video, wireless data transmission, charging, vibration, or any other function of a device that can be toggled with a switch. Because toggling the switch 102 involves applying some amount of force to the switch 102, the structure used to secure the switch 102 within the computing device 104 should be stable and rigid. In this way, the structure can ensure that the switch 102 is functional within the computing device 104 for the lifetime of the computing device 104.

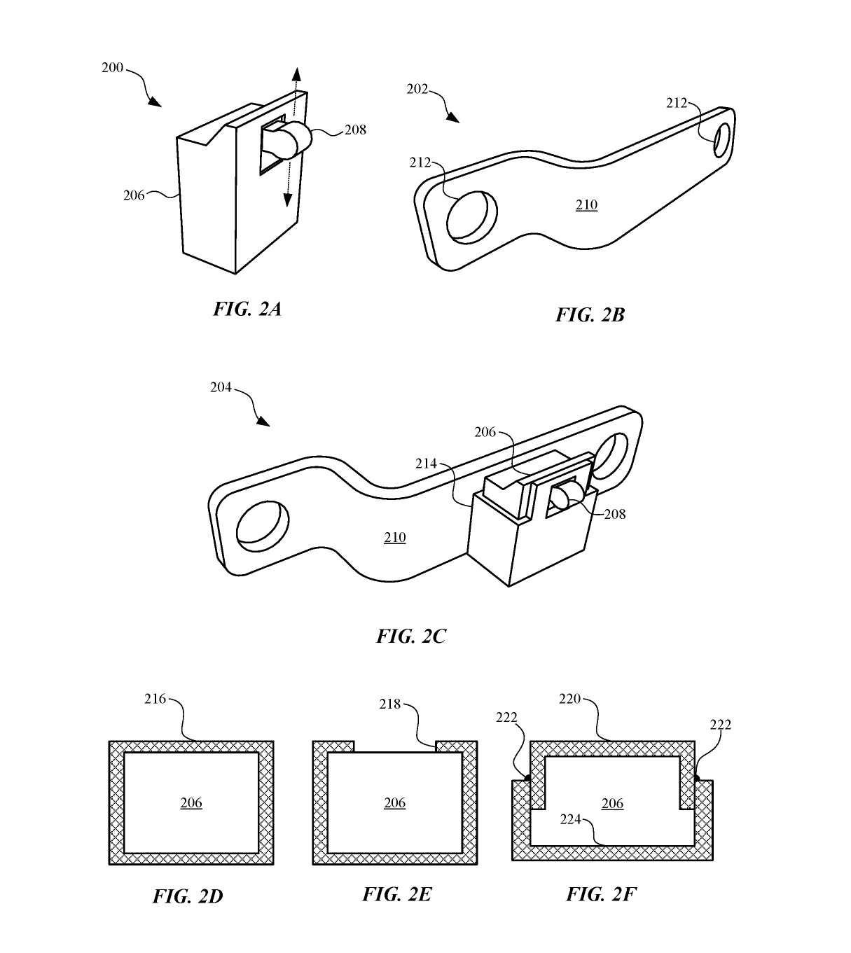

FIG. 2A illustrates a perspective view 200 of a switch 206 that can a part of the switch 102 of the computing device 104. The switch 206 can include a knob 208 that can be shifted in multiple direction, as indicated by the dotted arrows in FIG. 2A, to toggle an electrical component within the switch 206. By toggling the electrical component within the switch 206, functions of a device in which the switch 206 is connected can be executed. The switch 206 can be made of any suitable material not limited to metal or plastic. In order to secure the switch 206 within a device such as computing device 104, the switch 206 can be connected to a bracket 210, as illustrated in FIG. 2B. Specifically, FIG. 2B illustrates a perspective view 202 of the bracket 210 that can be secured within the computing device 104 with the switch 206. The bracket 210 can be planar or curved, as illustrated in FIG. 2B, in order to adequately secure the switch 206 at a location within the computing device 104 where a user can toggle the switch 206. In some embodiments, the bracket 210 can include one or more apertures 212 for securing the bracket 210 to another bracket, a substrate, housing, or other suitable surface of the computing device 104. FIG. 2C illustrates a perspective view 204 of the switch 206 wrapped in a switch cover 214 to secure the switch 206 to the bracket 210. The switch cover 214 can be made of a metal or metal alloy that can be welded to the bracket 210 through any process of welding suitable for securing an electrical component within the computing device 104. The switch cover 214 can wrap at least partially around or completely around the edges of the switch 206 such that a metal on metal connection is provided at a region between the bracket 210 and the switch 206. The bracket 210 can be uniform at the metal on metal connection or include one or more apertures at the metal on metal connection, as discussed herein. The switch cover 214 can at least partially extend over the surface of the switch 206 from which the knob 208 extends in order to create a rigid border around the knob 208 that can absorb forces that result from moving the knob 208.

FIGS. 2D-2F illustrate cross-sections of different embodiments of the switch cover 214. Specifically, FIG. 2D illustrates a cross section of an embodiment of the switch cover 214 in which a switch cover 216 wraps completely around a section of the switch 206. FIG. 2E illustrates a cross section of an embodiment of the switch cover 214 in which a switch cover 218 wraps partially around the switch 206 such that at least one side of the switch 206 is partially exposed. FIG. 2F illustrates a cross section of an embodiment of the switch cover 214 in which the switch cover 214 is two parts: a first switch cover 220 and a second switch cover 224. The first switch cover 220 and the second switch cover 224 can be welded together by welds 222 before or after the first switch cover 220 or the second switch cover 224 is attached to the bracket 210. Alternatively, the first switch cover 220 and/or the second switch cover 224 can be press fit, crimped, and/or laser welded to the switch 206 before attaching the first switch cover 220 and the second switch cover 224 to each other. In some embodiments, the first switch cover 220 and/or the second switch cover 224 can be press fit, crimped, and/or laser welded to the switch 206, without subsequently attaching the first switch cover 220 and the second switch cover 224 to each other. In yet other embodiments, the first switch cover 220 and/or the second switch cover 224 can be press fit, crimped, and/or laser welded to the switch 206 before attaching the first switch cover 220 and the second switch cover 224 to the bracket 210. In some embodiments, the second switch cover 224 is crimped to or press fit around a portion of the first switch cover 220 and/or the switch 206. Alternatively, the first switch cover 220 can be crimped to or press fit around a portion of the second switch cover 224 and/or the switch 206 In other embodiments, the second switch cover 224 can be laser welded to the bracket 210 and thereafter crimped to or press fit around the first switch cover 220 and/or the switch 206. In yet other embodiments, the first switch cover 220 and/or the second switch cover 224 can be insert molded to the switch 206, and thereafter the first switch cover 220 and the second switch cover 224 can optionally be welded together. By tightly securing the switch 206 between the first switch cover 220 and the second switch cover 224, movement of the internal components of the switch 206 can be mitigated during operation of the switch 206. Additionally, securing the switch 206 in this way improves the structural integrity of the switch 206 and allows the switch 206 to be made smaller and more compact without degrading performance of the switch 206.

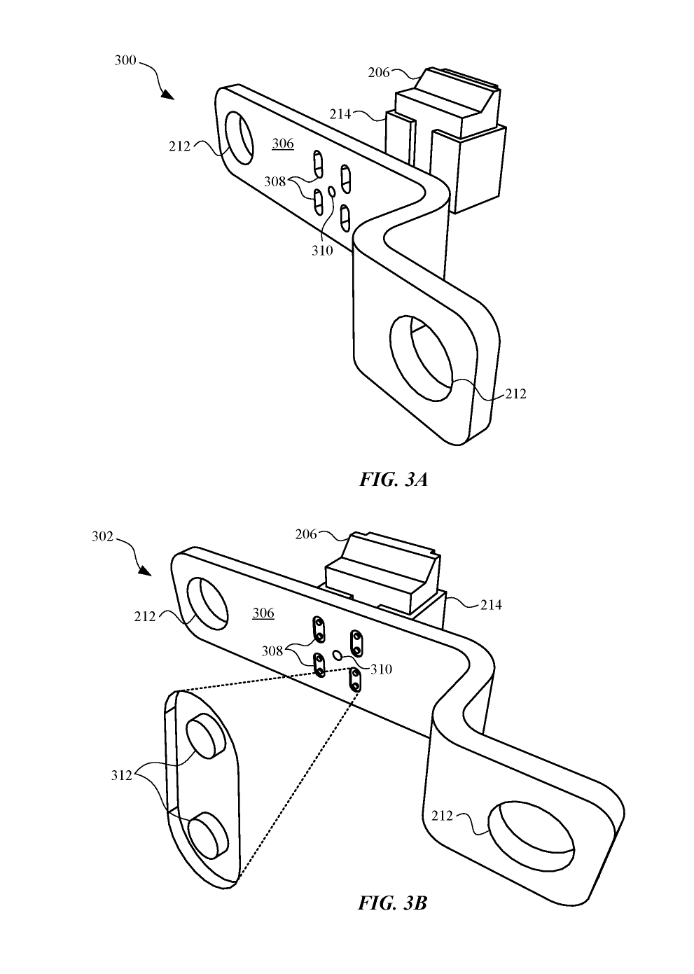

FIG. 3A illustrates a perspective view 300 of an embodiment of a bracket 306 having weld recesses 308 for welding a switch cover 214 to the bracket 306. The bracket 306 can include one or more weld recesses 308 that can be spaced an equal distance from a reference hole 310. In other embodiments, the weld recesses 308 can be spaced at non-equal distances from the reference hole 310. The reference hole 310 can be used by a sensor connected to a welding machine to determine whether the switch cover 214 and/or switch 206 are in a location suitable for welding the switch cover 214 to the bracket 306. In some embodiments, the reference hole 310 is not included in the bracket 306, and the sensor uses the switch cover 214 and/or switch 206 as a reference for determining whether the switch cover 214 and/or switch 206 are in a location suitable for welding the switch cover 214 to the bracket 306. FIG. 3B illustrates a perspective view 302 of the switch cover 214 welded to the bracket 306 using one or more welds 312. The welds 312 can be created in the bracket 306 by a laser welding process that directs a laser at the weld recesses 308 and switch cover 214 in a direction perpendicular or non-perpendicular relative to the bracket 306, as discussed herein. In some embodiments, a single weld 312 is made in each of the weld recesses 308. In other embodiments, multiple welds 312 are made in each of the weld recesses 308. However, it should be noted that any number of welds 312 can be made in each weld recess 308 for ensuring a rigid connection between the bracket 306 and the switch cover 214. During welding of the switch cover 214 to the bracket 306, one or more sliders can be used to secure the switch cover 214 in a position against the bracket 306 near the weld recesses 308. The sliders can include any positioning device suitable for holding an electrical component in place during manufacturing of a device in which the component is to be secured. One or more sliders can be disposed on top, bottom, and/or sides of the switch 206 during welding of the switch cover 214 to the bracket 306.

In some embodiments, the switch cover 214 can be flush against the bracket 306 when the switch cover 214 is being laser welded to the bracket 306. In such embodiments, the reference hole 310 can be absent from the bracket 306. In this way, a water tight seal can be created between the switch cover 214 and the bracket 306, thereby eliminating the need to apply additional sealants at the connection of the switch cover 214 and the bracket 306. In some embodiments, the bracket 306 can be part of an insert molded part, machined part, metal injection molded (MIM) part, and/or forged part to provide an optimal geometry for sealing each of the bracket 306, the insert molded, forged, machined, or MIM part, and/or the switch 206.

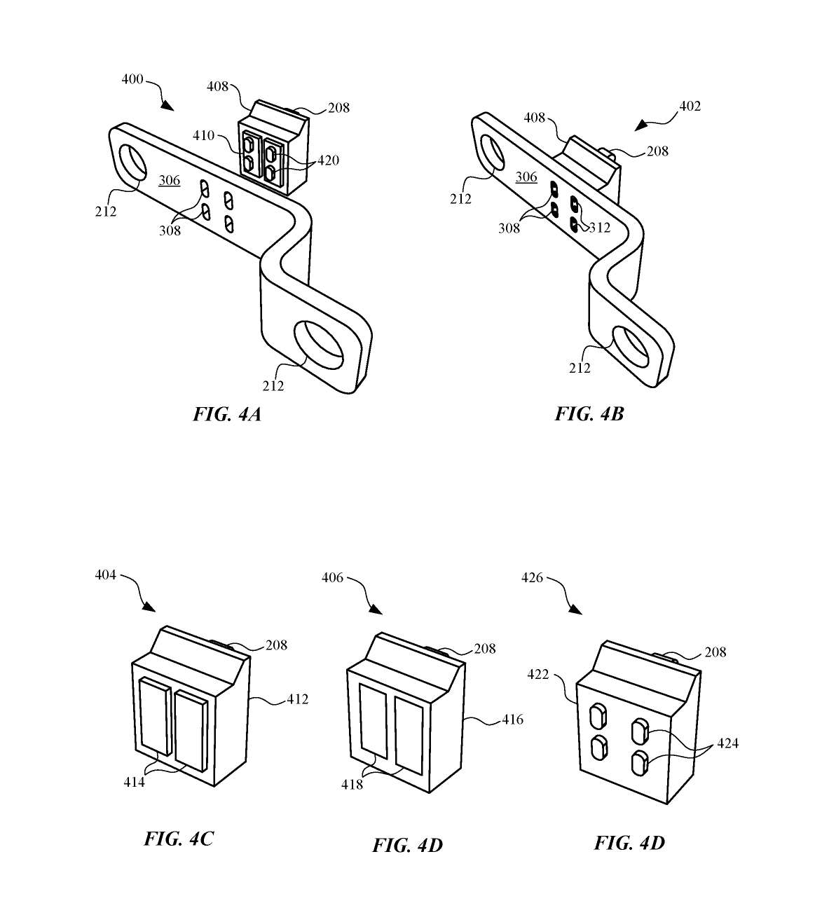

FIG. 4A illustrates a perspective view 400 of an embodiment of a switch 408 that can be secured to the bracket 306. The switch 408 can be similar to the other switches discussed herein, except that the switch 408 can be insert molded to include metal surfaces 410 and one or more metal pins 420. The metal pins 420 can be formed to have a shape that is capable of being received within recesses of the bracket 306, such that the metal surfaces 410 abut a surface of the bracket 306 when at least one of the metal pins 420 is within a recess of the bracket 306. The recesses for the metal pins 420 can be on an opposite side of the bracket 306 relative to the weld recesses 308. In some embodiments, the weld recesses 308 are apertures that extend through the bracket 306 such that the metal pins 420 can be placed within the apertures during welding of the switch 408 to the bracket 306. In yet other embodiments, the weld recesses 308 can be absent from the bracket 306 such that only the recesses for the metal pins 420 are provided on the bracket 306. FIG. 4B illustrates a perspective view 402 of the switch 408 welded to the bracket 306. The switch 408 can be welded to the bracket 306 according to any of the welding methods discussed herein in order to create one or more welds 312 that will secure switch 408 to the bracket 306 over the lifetime of the switch 408. FIG. 4C illustrates a perspective view 404 of an embodiment of a switch 412 that can be welded to the bracket 306 using one or more metal surfaces 414. The metal surfaces 414 differ from the metal surfaces 410 in that the metal surfaces 414 do not include the metal pin 420. Rather, the metal surfaces 414 include planar surface that extend out of the switch 412. Alternatively, FIG. 4D illustrates a perspective view 406 of a switch 416 that includes metal surfaces 418 that can be injection molded to be flush with a side of the switch 416. In this way, the side of the switch 416 will abut a surface of the bracket 306 when the bracket 306 and the switch 416 are welded together. It should be noted that any of the embodiments discussed herein can be combined in whole or part to create other embodiments. For example, the metal surfaces 418 can be planar surfaces or include the metal pins 420 of FIG. 4A for securing the switch 416 to the bracket 306. Moreover, as illustrated in a perspective view 426 of FIG. 4D, a switch 422 can include insert molded metal pins 424 that extend from a surface of the switch 422. The metal pins 424 can be formed to fit into recesses of the bracket 306 such that one or more welds can be created for each of the recesses. The metal pins discussed herein can be any suitable shape not limited to a polygon, circle, and/or oval, and can include one or more flat surface and/or curved surfaces.

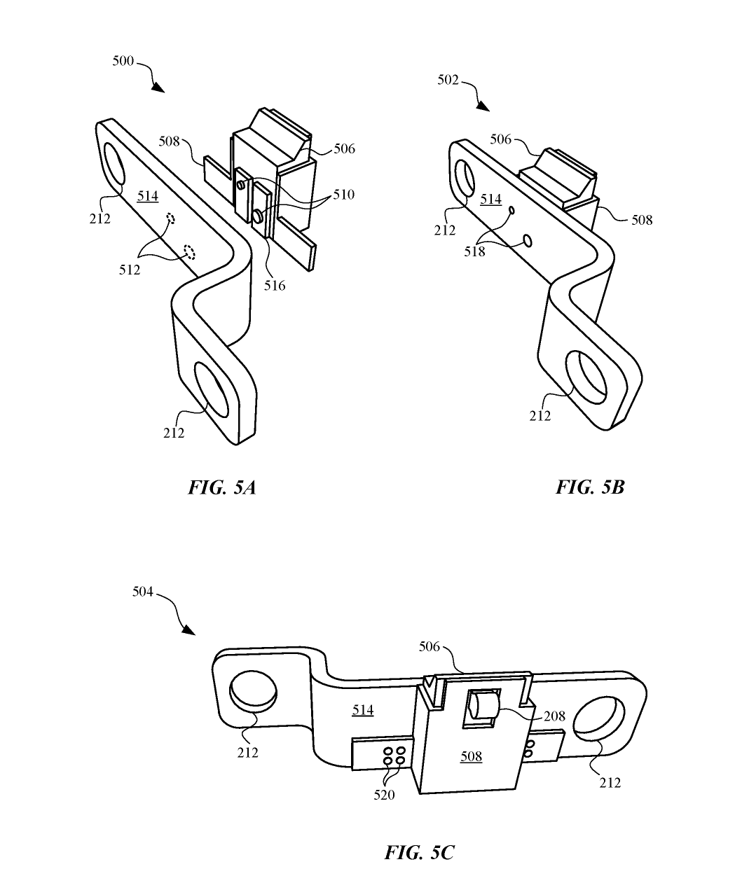

FIG. 5A illustrates a perspective view 500 of an assembly for securing a switch 506 to a bracket 514 using asymmetric alignment pins 510. The alignment pins 510 can extend from one or more metal surfaces 516 that can be insert molded or otherwise attached to the switch 506. Each of the alignment pins 510 can be of the same or different shape in order to ensure proper placement of the alignment pins 510 within recesses 512 of the bracket 514. The recesses 512 can be included on a surface of the bracket 514 that faces the alignment pins 510. By using alignment pins 510 of different shapes, it can be ensured that there is only one way the alignment pins 510 will concurrently fit into the recesses 512 of the bracket 514. Alternatively, and in some embodiments, the alignment pins 510 can be on a surface of the bracket 514, and the recesses 512 can be on one or more of the metal surfaces 516, a plastic surface of the switch 506, or a combination thereof. In this way, the alignment pins 510 on the surface of the bracket 514 can reside in the recesses 512 of the metal surfaces 516 of the switch 506 during laser welding of the bracket 514 to the switch 506.

A switch cover 508 can also be attached to the switch 506 using an adhesive and/or interlocking mechanism. The switch cover 508 can include surfaces that project away from the switch 506 for welding the surfaces to the bracket 514. FIG. 5B illustrates a perspective view 502 of the switch cover 508 secured to the bracket 514 using welds 518. The welds 518 can at least partially combine the metal of the bracket 514 with the metal of the alignment pins 510. The welds 518 can be flush and/or co-planar with a surface of the bracket 514 opposing the switch cover 508, or protrude into a portion of the surface of the bracket 514 opposing the switch cover 508. Additionally, welds 520 can be provided on the switch 506 in order to further secure the switch 506 to the bracket 514, as illustrated in a perspective view 504 of FIG. 5C. Specifically, FIG. 5C illustrates multiple welds 520 that can secure surfaces of the switch cover 508 adjacent to the switch 506. In this way, forces absorbed by the knob 208 will not reduce the strength of the metal on metal bond between the switch cover 508 and the bracket 514.

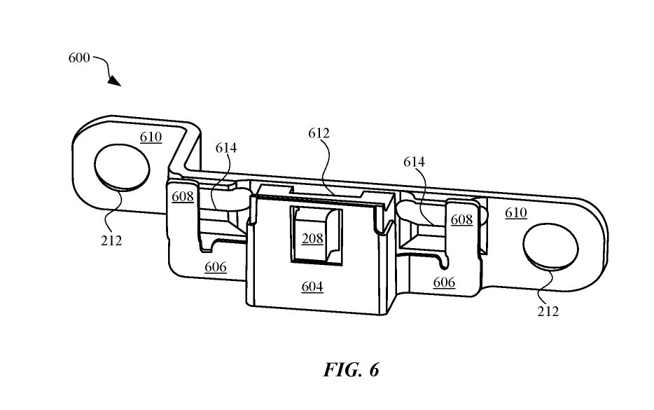

FIG. 6 illustrates a perspective view 600 of an embodiment of a switch assembly that includes a bracket 610 connected to a switch 612 and a switch cover 604. The bracket 610 can include a protruding structure 614 for resisting bending of the bracket 610 and the switch cover 604 when the knob 208 receives a force of pressure to move the knob 208. An arm 608 extending from a sidewall 606 of the switch cover 604 can extend over and against the protruding structure 614 to act as a resistance mechanism against forces received by the knob 208. As a result, there will be less ware on any weld that is provided between the switch 612, the switch cover 604, and/or the bracket 610. In some embodiments, welds can be provided directly between the switch 612 and the bracket 610, the sidewall 606 and the bracket 610, and/or the arm 608 and the bracket 610.

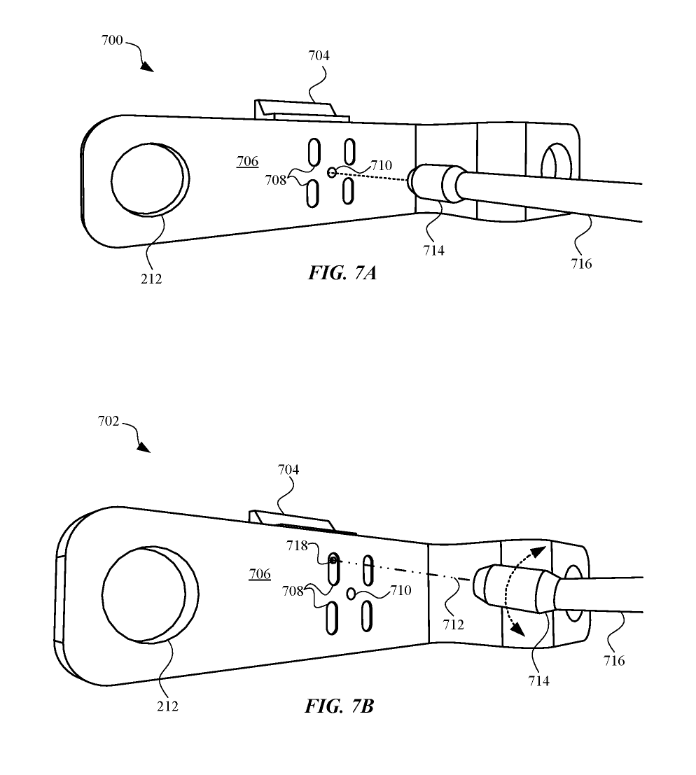

FIGS. 7A and 7B illustrate steps for welding a switch 704 to a bracket 706. Specifically, FIG. 7A illustrates a perspective view 700 of a welder 716 that can scan the bracket 706 to determine a location of a reference hole 710 or other indicia on the bracket 706. Scanning can be performed by a sensor that is attached to, or separate from, the welder 716. Once the reference hole 710 or indicia is found, the welder 716 can adjust a position of a welding head 714 of the welder 716 to aim at or near one or more weld recesses 708. The weld recesses 708 can be identified by a computer attached to the sensor that found the reference hole 710. In some embodiments, the computer can determine the location of the weld recesses 708 based on stored information about the bracket 706 to be welded. The computer can store coordinates or distances for calculating the location of the weld recesses 708 based on data from the sensor. For example, if the reference hole 710 is determined to be at location (x_1, y_1), the computer can determine a certain weld recess 708 is offset from the location (x_1, y_1) by a distance (m_1, n_1), and thereafter locate the certain weld recess 708 accordingly.

Once a location of a weld recess 708 has been determined, the welding head 714 can be shifted or rotated in order to direct a laser 712 at a certain weld recess 708 and create a weld 718, as illustrated in the perspective view 702 of FIG. 7B. One or more welds 718 can be created in each weld recess 708 by shifting or rotating the welding head 714 after each weld 718 is created. Each weld 718 can be created in a matter of milliseconds and brief pauses between welds can be undertaken in order to allow each weld 718 to dissipate heat before continuing to weld the bracket 706.

The welder can 716 adjust an amount of energy it uses to create a weld in the bracket 706. For example, when the welder 716 is a laser welder, the welder 716 can adjust an amount of power that is used to create the laser for each weld. In some embodiments, the sensor is capable of determining a thickness of the bracket 706. The computer connected to the sensor can then use the thickness determination as a feedback signal and adjust the amount of power for the laser based on the thickness of the bracket 706. In this way, each weld can be generated based on the thickness of the bracket 706 and/or the location of the weld recess 708 on the bracket 706.

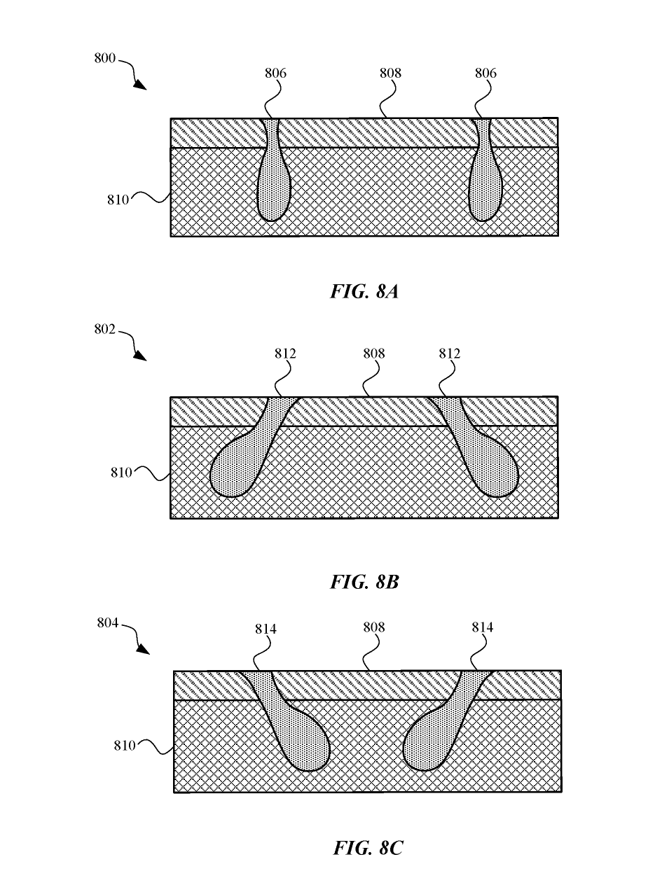

FIGS. 8A-8C illustrate cross-sectional views of welds that can be created to attach any of the switches and brackets discussed herein. Specifically, FIG. 8A illustrates a cross-sectional view 800 of a metal surface 810 disposed on a switch, and a bracket surface 808. The metal surface 810 and the bracket surface 808 can be welded together using one or more welds 806 that are formed by laser welding the metal surface 810 and the bracket surface 808. The welds 806 can result from a laser weld that is created by aiming a laser substantially perpendicular to the bracket surface 808 and/or the metal surface 810. However, in any of the embodiments discussed herein, the laser can be aimed at different directions in order to create other weld orientations. For example, FIG. 8B illustrates a cross-sectional view 802 of the metal surface 808 and the bracket surface 808 with an angled weld 812 connecting the metal surface 810 and the bracket surface 808. The angled weld 812 can be created such that each angled weld 812 extends away from each other as the angled welds 812 extend into the metal surface 810 and away from the bracket surface 808. The angled welds 812 can be formed by aiming a laser at an angle towards the bracket surface 808 and/or the metal surface 810. In some embodiments, the welds can be angled towards each other as the welds extend into the metal surface 810 and away from the bracket surface 808, as illustrated in FIG. 8C. Specifically, FIG. 8C shows a cross-sectional view 804 of angled welds 814 formed by aiming a laser at an angle towards the bracket surface 808 and/or the metal surface 810. Although FIG. 8C shows the angled welds 814 extending in different directions, in some embodiments the angled welds can be formed by aiming a laser at different points on the bracket surface 808 at the same angle.

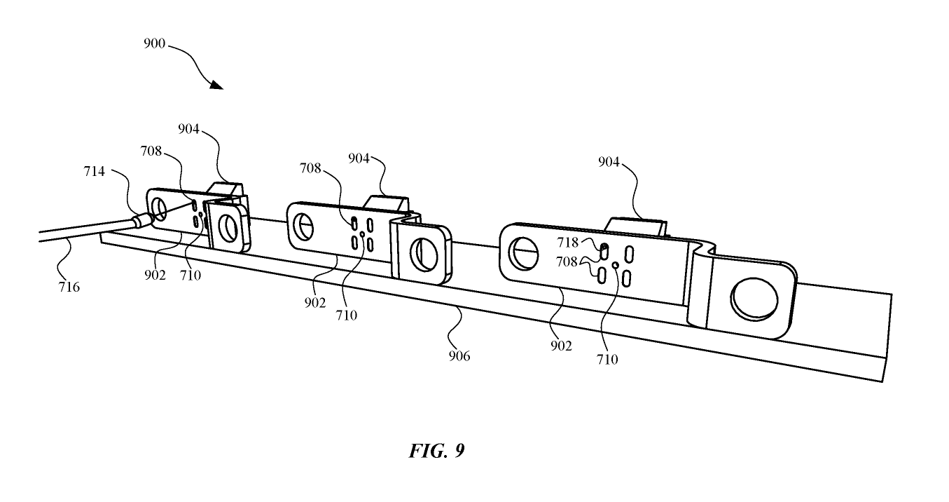

FIG. 9 illustrates a perspective view 900 of a pallet 906 of brackets 902 and switches 904 that can be connected together using a batch welding process. During the batch welding process, the welding head 714 of the welder 716 can be iteratively positioned proximate to each bracket 902 on the pallet 906 for welding each bracket 902. For example, the computer operating the welder can identify a reference hole 710 of a bracket 902 and derive a location of a weld recess 708 on the bracket 902. The welder 716 and welding head 714 can thereafter be positioned to make one or more welds 718 within the weld recess 708, and then move toward another bracket 902 on the pallet 906. Once one or more welds 718 have been made on each bracket 902 on the pallet 906, the welder 716 can be positioned near the first bracket 902 that was welded in order to make additional welds 718 on the first bracket 902. Thereafter, the welder 716 can be make additional welds 718 on the other brackets 902 on the pallet 906. In this way, heat from the welds on each bracket 902 can dissipate between welds in order to prevent destruction and/or deformation of the brackets 902 because of excessive heat. It should be noted that the welds 718 can be any shape not limited to a circle, oval, polygon, dot, and/or any other weld shape suitable for securing a component to a bracket. Furthermore, when welding multiple brackets 902 on a pallet 906, a single weld or multiple welds can be made on each bracket 902 before the welder 716 moves to a different bracket 902. Additionally, the first weld 718 on each bracket 902 can be created by a laser weld that is of a higher power than the other welds 718 made on each bracket 902. Each weld can vary in time and power based on feedback provided from a sensor that is connected to the computing controlling the welder 716. The sensor can measure the dimensions of the bracket 902, dimensions of the switch 904, cleanliness of the weld head 714, number of brackets 902 on the pallet, orientation of the bracket 902 and/or switch 904, or any other data suitable for making decisions on how to weld a component.

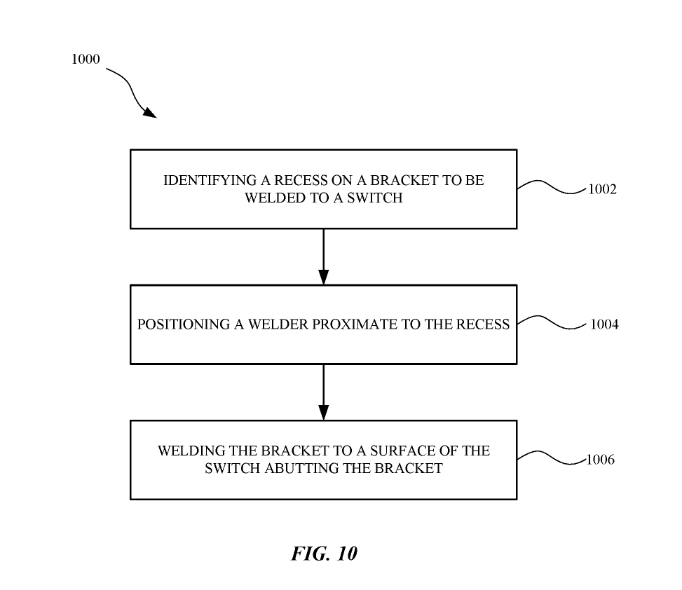

FIG. 10 illustrates a method 1000 for welding a bracket to a switch. The method 1000 can be performed by a computer or any device suitable for controlling the welding of a bracket to a switch. The method 1000 can include a step 1002 of identifying a recess on a bracket to be welded. The method 1000 can further include a step 1004 of positioning a welder proximate to the recess. Additionally, the method 1000 can include a step 1006 of welding the bracket to a surface of a switch abutting the bracket.

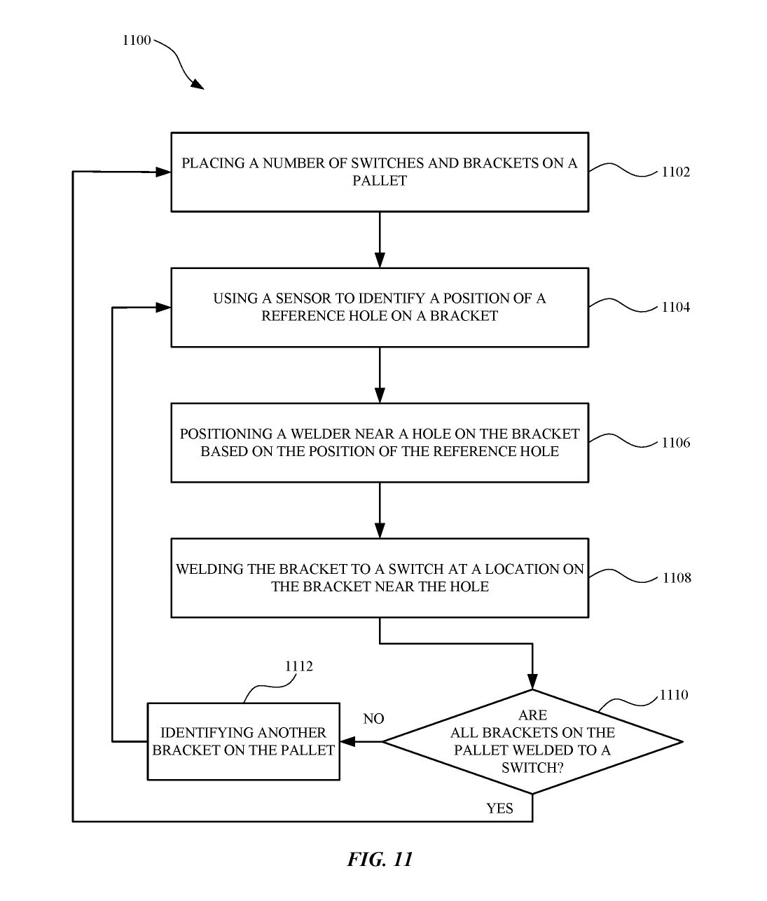

FIG. 11 illustrates a method 1100 for performing a batch welding process to individually weld multiple brackets to multiple switches. The method 1100 can be performed by a computer or any device suitable for controlling the welding of a bracket to a switch. The method 1100 can include a step 1102 of placing a number of switches and brackets on a pallet. At step 1104, a sensor is used to identify a position of a reference hole on a bracket. At step 1106, a welder is positioned near a recess on the bracket based on the position of the reference hole. At step 1108, the bracket is welded to the switch at a location near the recess. At step 1110, a determination is made whether all brackets on the pallet have been welded to a switch. If all brackets have been welded to a switch, then the step 1102 is repeated to assemble another pallet of switches and brackets. If all brackets on the pallet have not been welded, then at step 1112, another bracket on the pallet is identified and step 1104 is thereafter repeated to ensure that each bracket on the pallet is welded to a switch before another pallet of brackets and switches is assembled.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a computer readable medium for controlling manufacturing operations or as computer readable code on a computer readable medium for controlling a manufacturing line. The computer readable medium is any data storage device that can store data, which can thereafter be read by a computer system. Examples of the computer readable medium include read-only memory, random-access memory, CD-ROMs, HDDs, DVDs, magnetic tape, and optical data storage devices. The computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. A method for welding a bracket to a switch, the method comprising:
positioning a welder at a distance from a recess on the bracket, wherein the switch is positioned on a surface of the bracket opposite the recess; and
laser welding the bracket at the recess to attach the bracket to a metal surface of the switch.

2. The method of claim 1, wherein the bracket includes multiple recesses and the method further comprises laser welding the bracket at each of the multiple recesses.

3. The method of claim 1, further comprising:
identifying a location of a reference hole or indicia on the bracket; and
moving the welder toward the recess based on the location of the reference hole or indicia.

4. The method of claim 1, wherein the metal surface of the switch is insert molded onto a body of the switch.

5. The method of claim 1, wherein the metal surface is part of a switch cover that at least partially surrounds a body of the switch.

6. The method of claim 1, wherein positioning the welder at the distance from the recess includes orienting the welder in a direction that is not perpendicular to a surface of the bracket.

7. The method of claim 1, wherein the switch is at least partially made of plastic and includes a knob that extends away from the welder during the laser welding.

8. A switch assembly, comprising:
a bracket; and
a switch that is connected to the bracket at multiple laser welded regions, wherein each of the multiple laser welded regions are formed from at least one bracket surface and a metal surface of the switch.

9. The switch assembly of claim 8, wherein the switch includes multiple metal surfaces that are insert molded onto a plastic surface of the switch.

10. The switch assembly of claim 8, wherein the metal surface of the switch is a portion of a switch cover that is disposed over multiple edges of the switch.

11. The switch assembly of claim 10, wherein the switch includes a switch body, and distal ends of the switch cover are disposed between the bracket and the switch body.

12. The switch assembly of claim 10, wherein the switch includes a knob that extends through an aperture of the switch cover that is on an opposite side of the switch relative to the multiple laser welded regions.

13. The switch assembly of claim 8, wherein the bracket includes a recess at at least one of the multiple laser welded regions.

14. A method for manufacturing a switch assembly, the method comprising:
identifying a reference hole on a bracket, wherein the bracket is placed against a metal surface of a switch;
determining a location to weld the bracket based on the identifying of the reference hole; and
laser welding the bracket at the location to attach the bracket to the metal surface of the switch.

15. The method of claim 14, wherein the metal surface of the switch is part of a switch cover that at least partially wraps around a perimeter of the switch.

16. The method of claim 15, wherein the switch includes a knob that extends through an aperture of the switch cover.

17. The method of claim 14, wherein the bracket includes multiple recesses, and the method includes laser welding the bracket at each recess.

18. The method of claim 17, wherein the reference hole is located between the multiple recesses.

20. The method of claim 19, wherein the metal surface includes a pin that extends through a portion of the bracket when the laser welding is performed.
